(19) United States
(12) Patent Application Publication
(10) Pub. No.: US 2025/0293309 A1
(43) Pub. Date: Sep. 18, 2025

(54) ALL-SOLID-STATE BATTERY, MANUFACTURING EQUIPMENT OF THE SAME, AND MANUFACTURING METHOD OF THE SAME

(71) Applicant: SAMSUNG SDI CO., LTD., Yongin-si, Gyeonggi-do (KR)

(72) Inventors: Mansoo SHIN, Yongin-si, Gyeonggi-do (KR); Jeonghoon KIM, Yongin-si, Gyeonggi-do (KR)

(21) Appl. No.: 18/860,037

(22) PCT Filed: Apr. 26, 2023
(86) PCT No.: PCT/KR2023/005648

§ 371 Date: Oct. 25, 2024

(30) Foreign Application Priority Data
Apr. 26, 2022 (KR) 10-2022-0051405
Apr. 6, 2023 (KR) 10-2023-0045633

(51) Int. Cl. H01M 10/0585; H01M 10/0562; H01M 50/449

(52) U.S. Cl. CPC H01M 10/0585; H01M 10/0562; H01M 50/449

(57) ABSTRACT

An exemplary all-solid-state battery includes a positive electrode in which a positive electrode layer may be provided on both surfaces of a positive electrode current collector layer, a pair of solid electrolyte layers disposed on the both surfaces of the positive electrode, and a negative electrode disposed in each of the solid electrolyte layers and provided with a negative electrode layer on both surfaces of a negative electrode current collector layer, where an outer end portion of the solid electrolyte layer and an outer end portion of the negative electrode disposed on the same line in a thickness direction, where an outer end portion of the positive electrode have a first distance difference shorter than the outer end portion of the solid electrolyte layer, and where a gap of outer end portions of the pair of solid electrolyte layers and a side surface of the outer end portion of the positive electrode form a space between each other in which a gasket is interposed.

### TECHNICAL FIELD

The present disclosure relates to an all-solid-state battery, a manufacturing equipment thereof, and a manufacturing method thereof.

### BACKGROUND ART

Recently, in response to industrial demands, the development of batteries with high energy density and safety is being actively conducted. For example, lithium-ion batteries are being put into practical use not only in the fields of information-related devices and communication devices, but also in the automobile field. In the automotive field, safety is especially important because it involves life of people.

Lithium-ion batteries currently on the market use electrolytes containing flammable organic solvents, so there is a possibility of overheating and fire in the event of a short circuit. In this regard, an all-solid-state battery using a solid electrolyte instead of an electrolyte is being proposed.

Because the all-solid-state battery does not use a flammable organic solvent, the possibility of fire or explosion in the event of a short circuit may be considerably reduced. Therefore, the all-solid battery may considerably increase safety compared to the lithium ion battery using the electrolyte solution.

The above information disclosed in this background section is only for enhancement of understanding of the background of the disclosure, and therefore it may contain information that does not form the prior art that is already known in this country to a person of ordinary skill in the art.

### DISCLOSURE

### Technical Problem

The present disclosure provides an all-solid-state battery manufactured by using a new die cavity structure for isostatic pressing. The present disclosure provides a manufacturing equipment and a manufacturing method of an all-solid-state battery having a new die cavity structure for isostatic pressing.

### Technical Solution

An exemplary manufacturing equipment of an all-solid-state battery according to the present disclosure may include a metal die of a flat plate shape, a rubber die disposed on the metal die and having a cavity, a lamination film configured to cover the rubber die including the cavity after the all-solid-state battery is disposed in the cavity of the rubber die, and a rubber punch configured to cover the lamination film.

When isostatic pressing is applied to the rubber die by the rubber punch, the rubber die may be deformed to provide elasticity such that a side wall of the cavity may contact the all-solid-state battery.

When the isostatic pressing on the rubber die due to the rubber punch is released, the rubber die may be restored to an original state to provide elasticity for the side wall of the cavity to become spaced apart from the all-solid-state battery.

The rubber die may include urethane, silicon, or elastomer. The lamination film may be of a flat plate shape. The rubber punch may be of flat plate shape.

The rubber die may further include a tab cavity connected to the cavity, and configured to surround a positive electrode tab and a negative electrode tab of the all-solid-state battery.

The rubber die may be provided in a plural quantity along at least one direction among a first direction and a second direction crossing each other, to form an area of the cavity.

The metal die may be formed as a plurality of flat plates corresponding to a plurality of rubber dies, respectively, or formed as one flat plate entirely supporting the plurality of rubber dies.

The rubber die and the rubber punch may be disposed on an upper surface of the metal die and configured to pressurize the all-solid-state battery on a first surface of the metal die.

The rubber die and the rubber punch may include a first die and a first punch disposed on an upper surface of the metal die and configured to pressurize the all-solid-state battery on a first surface of the metal die, and a second die and a second punch disposed on a lower surface of the metal die and configured to pressurize the all-solid-state battery on other both surfaces of the metal die.

The metal die may include a flat surface portion coupled to the cavity of the rubber die and planarly formed to protrude to support the all-solid-state battery inserted into the cavity.

An exemplary a manufacturing method of an all-solid-state battery according to the present disclosure may include a first step of preparing a metal die of a flat plate shape, a second step of disposing a rubber die having a cavity on the metal die, a third step of disposing an all-solid-state battery in the cavity of the rubber die, a fourth step of covering the all-solid-state battery and the rubber die by a lamination film, a fifth step of covering the lamination film by a rubber punch, and a sixth step of applying an isostatic pressing to the rubber punch.

In the sixth step, when the isostatic pressing is applied by the rubber punch, the rubber die may be deformed such that a side wall of the cavity may contact the all-solid-state battery.

In the sixth step, when the isostatic pressing is released by the rubber punch, the rubber die may be restored to an original state such that a side wall of the cavity may become spaced apart from the all-solid-state battery.

In the sixth step, the isostatic pressing may be performed hydraulically using water or oil.

An all-solid-state battery may be manufactured by the manufacturing method described above.

In the third step, a positive electrode tab and a negative electrode tab of the all-solid-state battery may be disposed in a tab cavity of the rubber die.

An exemplary all-solid-state battery according to the present disclosure may include a positive electrode in which a positive electrode layer may be provided on both surfaces of a positive electrode current collector layer, a pair of solid electrolyte layers disposed on the both surfaces of the positive electrode, and a negative electrode disposed in each of the solid electrolyte layers and provided with a negative electrode layer on both surfaces of a negative electrode current collector layer, where an outer end portion of the solid electrolyte layer and an outer end portion of the negative electrode disposed on the same line in a thickness direction, where an outer end portion of the positive electrode have a first distance difference shorter than the outer end portion of the solid electrolyte layer, and where a gap of outer end portions of the pair of solid electrolyte layers and a side surface of the outer end portion of the positive electrode form a space between each other in which a gasket is interposed.

An inner side of the gasket may be in line with the thickness direction and planarly contact the outer end portion of the positive electrode.

An outer end portion of the gasket may be disposed on the same line with the outer end portion of the solid electrolyte layer in the thickness direction.

An outer end portion of the gasket may protrude beyond the outer end portion of the solid electrolyte layer.

An outer end portion of the gasket may have a second distance difference shorter than the outer end portion of the solid electrolyte layer.

An inner side of the gasket may form a protrusions-and-depressions structure in the thickness direction, and contact the positive electrode end portion through the protrusions-and-depressions structure.

The inner side of the gasket may form a concave structure in the thickness direction, and contacts a convex structure of the positive electrode end portion.

An exemplary a manufacturing method of an all-solid-state battery according to the present disclosure may include a first step of disposing an all-solid-state battery in a cavity of a rubber die having the cavity on a metal die of a flat plate shape, the all-solid-state battery including a negative electrode, a first solid electrolyte layer, a positive electrode, a second solid electrolyte layer, and the negative electrode, and being provided with a gasket between the first solid electrolyte layer and the second solid electrolyte layer, and forming a space defined by the gasket between the first solid electrolyte layer and the second solid electrolyte layer, a second step of covering the all-solid-state battery and the rubber die by a lamination film, a third step of applying isostatic pressing to the lamination film to fill the space by deformation of the gasket, and a fourth step of restoring the rubber die by releasing the isostatic pressing of the lamination film.

Being provided with the gasket in the first step may include being provided with a first member on the first solid electrolyte layer, and being provided with a second member on the second solid electrolyte layer to face the first member.

Due to deformation of the gasket in the third step, the first member and the second member may be deformed to form one gasket.

In the third step, a uniform wall may be formed on an outer boundary of the all-solid-state battery by an elastic force of the rubber die.

In the fourth step, separation of the lamination film from the all-solid-state battery may be supported by a restoring force of the rubber die.

### Advantageous Effects

The present disclosure may provide a manufacturing equipment and a manufacturing method of an all-solid-state battery that can prevent trouble from the delamination process through a die cavity structure formed by a metal die and a rubber die. Moreover, the present disclosure may provide an all-solid-state battery according to this manufacturing equipment and manufacturing method.

The present disclosure may minimize the gap between the cavity and the pressurization sample during isostatic pressing, which may minimize the gap penetration of the lamination film, and moreover, it may prevent adhesion between the lamination film and the pressurization sample by applying tension to the slightly penetrated lamination film after the completion of isostatic pressing. Accordingly, the present disclosure may resolve the process trouble of the delamination step.

The present disclosure may minimize the usage of consumable outer bodies by only consuming the lamination film, as it repeatedly uses the metal die and the rubber die. Therefore, manufacturing and variable costs can be reduced. The present disclosure may facilitate the automation of the attachment and removal process by making it easier to attach and remove the consumable outer body, as it repeatedly uses the metal die and rubber die. Therefore, manufacturing and fixed costs can be reduced and productivity can be improved.

The present disclosure may provide a uniform outer boundary size and shape in an all-solid-state battery by using the elasticity and recovery of the rubber die on the metal die to fill the gasket between the positive electrode and the solid electrolyte layer.

### DESCRIPTION OF THE DRAWINGS

FIG. 1 is a cross-sectional view of an exemplary all-solid-state battery according to the present disclosure.

FIG. 2A is an exploded perspective view showing an exemplary manufacturing equipment of an all-solid-state battery according to the present disclosure.

FIG. 2B is a cross-sectional view of a manufacturing equipment of the all-solid-state battery of FIG. 2A taken along line B-B.

FIG. 3A is an exploded perspective view showing another exemplary manufacturing equipment of an all-solid-state battery according to the present disclosure.

FIG. 3B is a cross-sectional view showing pressing of a single surface of an all-solid-state battery by the manufacturing equipment of the all-solid-state battery of FIG. 3A.

FIG. 3C is a cross-sectional view showing pressing of both surfaces of an all-solid-state battery by a still another manufacturing equipment of an all-solid-state battery according to the present disclosure.

FIG. 4 is an enlarged perspective view showing a structure of the die cavity of FIG. 2A.

FIG. 5 is an enlarged perspective view showing a side surface of the all-solid-state equipment of FIG. 2A.

FIG. 6 is a flowchart showing a manufacturing method of an all-solid-state battery using an exemplary manufacturing equipment of an all-solid-state battery according to the present disclosure.

FIG. 7 is a flowchart schematically showing a lamination process and a delamination process among the manufacturing method of the all-solid-state battery of FIG. 6.

FIG. 8 is a cross-sectional view showing states of the die cavity before and after the pressing by the manufacturing method of the all-solid-state battery of FIG. 6.

FIG. 9 is an exploded perspective view showing an exemplary manufacturing equipment of an all-solid-state battery according to the present disclosure and first all-solid-state battery.

FIG. 10 is a perspective view showing an assembly of a first all-solid-state battery and the manufacturing equipment of the exemplary all-solid-state battery of FIG. 9.

FIG. 11 is a cross-sectional view of FIG. 10 taken along line XI-XI.

FIG. 12 is a cross-sectional view of FIG. 10 taken along line XII-XII.

FIG. 13 is a flowchart showing a manufacturing method of an all-solid-state battery using an exemplary manufacturing equipment of an all-solid-state battery according to the present disclosure.

FIG. 14 is a partial cross-sectional view of the first all-solid-state battery and the manufacturing equipment of the all-solid-state battery in the first step among the manufacturing method of FIG. 13.

FIG. 15 is a partial cross-sectional view of the first all-solid-state battery and the manufacturing equipment of the all-solid-state battery in the third step among the manufacturing method of FIG. 13.

FIG. 16 is a partial cross-sectional view of the first all-solid-state battery and the manufacturing equipment of the all-solid-state battery in the fourth step among the manufacturing method of FIG. 13.

FIG. 17 is a partial cross-sectional view of the second all-solid-state battery and the manufacturing equipment of the all-solid-state battery in the fourth step among the manufacturing method of FIG. 13.

FIG. 18 is a partial cross-sectional view of the third all-solid-state battery and the manufacturing equipment of the all-solid-state battery in the fourth step among the manufacturing method of FIG. 13.

### MODE FOR INVENTION

The preferred embodiments further illustrate the present disclosure specifically. However, these embodiments are only meant to facilitate understanding for those skilled in the art of the present disclosure and may be embodied in many different forms, so they should not be construed as being limited to the embodiments set forth herein. Rather, these embodiments are provided so that this disclosure will be thorough and complete, and will fully convey the scope of the present inventive concept to those skilled in the art.

In addition, in the accompanying drawings, sizes or thicknesses of various components are exaggerated for brevity and clarity, and like numbers refer to like elements throughout. As used herein, the term “and/or” may include any one and all combinations of one or more of the associated listed items. In addition, it should be understood that when an element A is referred to as being “connected to” an element B, the element A can be directly connected to the element B, or an intervening element C may be present therebetween such that the element A and the element B are indirectly connected to each other.

The terminology used herein is for the purpose of describing particular embodiments only and is not intended to be limiting of the disclosure.

As used herein, the singular forms are intended to include the plural forms as well, unless the context clearly indicates otherwise. It will be further understood that the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof.

It will also be understood that, although the terms first, second, and the like may be used herein to describe various members, elements, regions, areas, layers, and/or sections, these members, elements, regions, areas, layers and/or sections should not be limited by these terms. These terms are only used to distinguish one member, element, region, layer and/or section from another. Thus, for example, a first member, a first element, a first region, a first area, a first layer, or a first section described below could be termed a second member, a second element, a second region, a second area, a second layer, or a second section without departing from the teachings of the present disclosure.

In addition, terms related to a space, such as “beneath”, “below”, “lower”, “above”, “upper”, or the like, may be used for better understanding of elements or features shown in the drawing. It should be understood that such spatially relative terms are intended to encompass different orientations of the device in use or operation, in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both orientations of above and below.

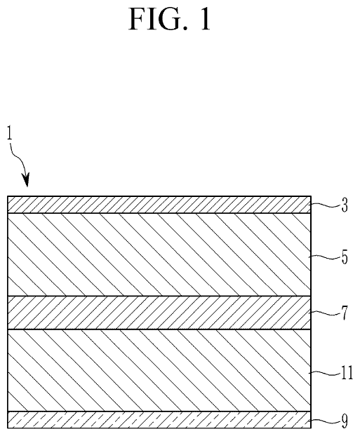

FIG. 1 is a cross-sectional view of an exemplary all-solid-state battery according to the present disclosure. FIG. 1 merely schematically show the configuration of an all-solid-state battery 1 for better comprehension, and ratios of respective thicknesses may be different from what is shown in FIG. 1.

As shown in FIG. 1, the exemplary all-solid-state battery 1 according to the present disclosure may include a negative electrode current collector layer 9, a negative electrode layer 11, a solid electrolyte layer 7 and a positive electrode layer 5, and a positive electrode current collector layer 3, which are consecutively installed from the bottom end. The solid electrolyte layer 7 provided between the negative electrode layer 11 and the positive electrode layer 5 may directly contact the negative electrode layer 11 and the positive electrode layer 5, respectively.

The negative electrode layer 11, the solid electrolyte layer 7, and the positive electrode layer 5 may be formed as powder, respectively, and may be formed by pressing. In addition, the planar shape of the all-solid-state battery 1 is not particularly limited, and may be circular or parallelepiped.

The negative electrode current collector layer 9 may be formed as a conductor, and may be formed of metal, for example, copper (Cu), nickel (Ni), stainless, nickel-plated steel plate, or the like. A thickness of the negative electrode current collector layer 9 may be, for example, about 10 μm to 20 μm.

The negative electrode layer 11 may include a negative active material in the powder form. The average particle diameter of the negative active material may be in a range of, for example, 5 μm to 20 μm. The content of the negative active material in the negative electrode layer 11 may be within a range of, for example, 60 wt % to 95 wt %. The negative electrode layer 11 may additionally include a binder, a solid electrolyte material in the powder form, a conductive material, or the like that does not cause a chemical reaction with the solid electrolyte layer 7.

As the negative active material, various known materials may be used, and for example, carbon active material, metal active material, oxide active material, or the like may be used. Examples of the carbon active material may include, for example, graphite such as artificial graphite and natural graphite, amorphous carbon such as hard carbon and soft carbon, or the like. Examples of the metal active material may include, for example, lithium (Li), indium (In), aluminum (Al), silicon (Si), tin (Sn), or the like. Examples of the oxide active material may include, for example, Nb₂O₅, Li₄Ti₅O₁₂, SiO, or the like. The negative active material may be used individually, or two or more types can be used together. A thickness of the negative electrode layer 11 is not particularly limited, but may be, for example, about 50 μm to 300 μm.

The solid electrolyte layer 7 may be formed of solid electrolyte in the powder form. The average particle diameter of the solid electrolyte may be in a range of, for example, 1 μm to 10 μm. As the solid electrolyte, for example, a sulfide-based solid electrolyte containing at least lithium (Li), phosphorus (P) and sulfur(S) may be used. An example of the sulfide-based solid electrolyte may be Li₂S—P₂S₅. The sulfide-based solid electrolyte shows good lithium ion conductivity, and may include a sulfide such as SiS₂, GeS₂, B₂S₃, in addition to Li₂S—P₂S₅. A thickness of the solid electrolyte layer 7 is not particularly limited, but may be, for example, about 10 μm to 200 μm. In addition, as the solid electrolyte, an inorganic solid electrolyte to which Li₃PO₄ and halogen or a halogen compound, or the like, may be used.

The Li₂S—P₂S₅ can be obtained by heating Li₂S and P₂S₅ above the melting temperature, melting and mixing the two at a predetermined ratio, maintaining the mixture for a predetermined time, and then rapidly cooling. This Li₂S—P₂S₅ may be obtained by processing the powder of Li₂S and P₂S₅ according to the mechanical milling method. The mixing ratio of Li₂S and P₂S₅ may be typically 50:50 to 80:20, preferably 60:40 to 75:25, in molar ratio.

The positive electrode layer 5 may include a positive active material in the powder form. The average particle diameter of the positive active material may be in a range of, for example, 2 μm to 10 μm. The content of the positive active material among the positive electrode layer 5 may be in a range of, for example, 65 wt % to 95 wt %. The positive electrode layer 5 may additionally include a binder, a solid electrolyte material in the powder form, a conductive material, or the like that does not cause a chemical reaction with the solid electrolyte layer 7.

Any material that can reversibly occlude and release lithium ions can be used as the positive electrode active material. For example, examples of the positive active material may include lithium cobalt oxide (LCO), lithium nickel oxide, lithium nickel cobalt oxide, lithium nickel cobalt aluminum oxide (NCA), lithium nickel cobalt manganese oxide (NCM), lithium manganese oxide, lithium iron phosphate, sulfide nickel, sulfide copper, sulfur, iron oxide, oxidation vanadium, or the like. The positive active material may be used individually, or two or more types can be used together.

For example, the positive electrode active material may be one or more types of complex oxides of lithium and a metal selected from cobalt, manganese, nickel, and combinations thereof, and a specific example may be a compound represented as one of Chemical Formula of LiaA1-bBbD2 (where, in this formula, 0.90≤a≤1, and 0≤b≤0.5); LiaE1-bBbO2-cDc (where, in this formula, 0.90≤a≤1, 0≤b≤0.5, 0≤c≤0.05); LiE2-bBbO4-cDc (where, in this formula, 0≤b≤0.5, 0≤c≤0.05); LiaNi1-b-cCobBcDa (where, in this formula, 0.90≤a≤1, 0≤b≤0.5, 0≤c≤0.05, 0<α≤2); LiaNi1-b-cCobBcO2-aFa (where, in this formula, 0.90≤a≤1, 0≤b≤0.5, 0≤c≤0.05, 0<α<2); LiaNi1-b-cCobBcO2-αF2 (where, in this formula, 0.90≤a≤1, 0≤b≤0.5, 0≤c≤0.05, 0<α<2); LiaNi1-b-cMnbBcDα (where, in this formula, 0.90≤a≤1, 0≤b≤0.5, 0≤c≤0.05, 0<α≤2); LiaNi1-b-cMnbBcO₂-αFα (where, in this formula, 0.90≤a≤1, 0≤b≤0.5, 0≤c≤ 0.05, 0<α<2); LiaNi1-b-cMnbBcO₂-αF2 (where, in this formula, 0.90≤a≤1, 0≤b≤0.5, 0≤c≤0.05, 0<α<2); LiaNibEcGdO₂ (where, in this formula, 0.90≤a≤1, 0≤b≤0.9, 0≤c≤0.5, 0.001≤d≤0.1.); LiaNibCocMndGeO₂ (where, in this formula, 0.90≤a≤1, 0≤b≤0.9, 0≤c≤0.5, 0≤d≤0.5, 0.001≤e≤0.1.); LiaNiGbO₂ (where, in this formula, 0.90≤a≤1, 0.001≤b≤0.1.); LiaCoGbO₂ (where, in this formula, 0.90≤a≤1, 0.001≤b≤0.1.); LiaMnGbO₂ (where, in this formula, 0.90≤a≤1, 0.001≤b≤0.1.); LiaMn2GbO₄ (where, in this formula, 0.90≤a≤1, 0.001≤b≤0.1.); QO₂; QS₂; LiQS₂; V₂O₅; LiV₂O₅; LiIO₂; LiNiVO₄; Li (3-f)J2(PO₄)3 (0≤f≤2); Li (3-f)Fe₂(PO₄)3 (0≤f≤2); LiFePO₄.

In above formula, A is Ni, Co, Mn, or a combination thereof; B is Al, Ni, Co, Mn, Cr, Fe, Mg, Sr, V, rare earth element or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

Among the above-described positive electrode active materials, a lithium salt of a transition metal oxide having a layered rock salt-type structure may be used. Here, the “rock salt-type structure” is a sodium chloride-type structure, which is a type of crystal structure, and refers to a structure in which the face-centered cubic lattice provided by each positive ion and negative ion are offset from each other by only ½ of the corners of the unit lattice. For example, the lithium salt of ternary transition metal oxides denoted as Li1-x-y-zNixCoyAlzO₂ (NCA) or Li1-x-y-zNixCoyMnZO₂ (NCM) (0<x<1, 0<y<1, 0<z<1, and x+y+z<1) may be used as the positive active material.

A compound that can be used as the positive electrode active material specifically disclosed above, having a coating layer on its surface, may also be used, or a mixture of the above compounds and a compound having a coating layer can be used. This coating layer may include a coating element compound of oxide of the coating element, hydroxide, oxyhydroxide of the coating element, oxycarbonate of the coating element, or hydroxycarbonate of the coating element. The compounds forming these coating layers may be amorphous or crystalline. As coating elements included in the coating layer, Mg, Al, Co, K, Na, Ca, Si, Ti, V, Sn, Ge, Ga, B, As, Zr, or a mixture thereof may be used. For the coating layer provision process, any coating method (e.g., spray coating, dipping method, etc.) may be used as long as these elements can be used in the compound to coat the compound in a manner that does not adversely affect the physical properties of the positive electrode active material, and since this is well-understood by a person skilled in the field, detailed explanation will be omitted.

Examples of a positive electrode layer conductive material may include, for example, graphite, carbon black, acetylene black, Ketjen black, carbon fiber, metal powder, or the like.

The positive electrode layer may additionally include the solid electrolyte. As the solid electrolyte of the positive electrode layer, conventionally known electrolytes can be used without limitation. Specifically, examples may include LisN, LISICON, lithium (LIPON), Thio-LISICON (Li3.25Ge0.25P0.75S₄), Li₂O—Al₂O₃—TiO₂—P₂O₅ (LATP), or the like. In addition, examples of the solid electrolyte having high ion conductivity may include Li₂S—P₂S₅, Li₃PS₄, Li₂P₃S₁₁, Li₆PS₅Cl, Li₃PO₄, or the like.

The ionic conductivity of Li₃PO₄ is 10⁻⁴-10⁻³ S/cm. The ionic conductivity of Li₇P₃S₁₁ is 10⁻³-10⁻² S/cm. The ionic conductivity of Li₆PS₅Cl is 10⁻⁴-10⁻³ S/cm. The ionic conductivity of Li₃PO₄ is 10⁻⁵-10⁻⁴ S/cm.

As a binder, for example, a non-polar resin without a polar functional group can be used. Therefore, the positive electrode layer binder may be inert to reactive solid electrolyte, particularly the sulfide-based solid electrolyte. Examples of the positive electrode layer binder may include, styrene-based thermoplastic elastomers such as styrene butadiene block copolymer (SBS), styrene ethylene butadiene styrene block copolymer (SEBS), styrene-(styrene butadiene)-styrene block copolymer, styrene butadiene rubber (SBR), butadiene rubber (BR), natural rubber (NR), isoprene rubber (IR), ethylene-propylene-diene terpolymer (EPDM), and partially or fully hydrogenated products thereof. In addition, polystyrene, polyolefin, olefin-based thermoplastic elastomer, polycycloolefin, silicone resin, or the like may be used as a binder. A thickness of the positive electrode layer 5 is not particularly limited, but may be, for example, about 50 μm to 350 μm.

The positive electrode current collector layer 3 may be formed of conductor, and may be formed of, for example, a metal such as aluminum (Al), stainless, or the like. A thickness of the positive electrode current collector layer 3 is not particularly limited, but may be, for example, about 10 μm to 20 μm. The planar areas of the negative electrode current collector layer 9, the negative electrode layer 11, the solid electrolyte layer 7, the positive electrode layer 5, and the positive electrode current collector layer 3 may be the same as shown in FIG. 1, and they may be installed such that the planar areas of the positive electrode layer 5 and the positive electrode current collector layer 3 is smaller than the planar areas of the negative electrode current collector layer 9, the negative electrode layer 11 and the solid electrolyte layer 7, and meanwhile, the planar exterior forms of the positive electrode layer 5 and the positive electrode current collector layer 3 is located inside the planar exterior form of the negative electrode current collector layer 9, the negative electrode layer 11 and the solid electrolyte layer 7. Since the planar areas of the positive electrode layer 5 and the positive electrode current collector layer 3 is smaller than the planar areas of the negative electrode current collector layer 9, the negative electrode layer 11 and the solid electrolyte layer 7, when pressure is applied to the negative electrode layer 11, the solid electrolyte layer 7 and the positive electrode layer 5, outward protrusion of the positive electrode layer 5 may be prevented, making it difficult for a short circuit to occur.

In addition, FIG. 1 illustrates a monopolar all-solid-state battery 1, but the all-solid-state battery 1 may be bipolar-typed. In addition, the monopolar cell structure of FIG. 1 may be stacked multiple times.

In addition, the all-solid-state battery 1 may not be necessarily an all-solid-state lithium ion rechargeable battery, and may be an all-solid-state alkali ion rechargeable battery (e.g., all-solid-state sodium ion rechargeable battery).

The all-solid-state battery 1 may require an ultra-high pressure process of approximately 500 MPa to secure the conductivity of electrons and ions, by stacking the negative electrode current collector layer 9, the negative electrode layer 11, the solid electrolyte layer 7, the positive electrode layer 5 and the positive electrode current collector layer 3, and by pressurizing and densifying them.

In order to implement such high-pressure process, the all-solid-state battery may be sealed in a bag, and inserted into and pressurized by a Wet Warm Isostatic Press (WIP) facility. For this purpose, a method is used to place the pressurization sample on a die of a flat plate shape, fix it, and then place it in a bag and seal it.

To explain the manufacturing method of an all-solid-state battery using an existing die and bag, first, place the pressurization sample on the die, fix it by taping, etc., place it in the bag outer body and vacuum seal it to protect the sample, by which preparation for pressurization is completed. When pressurization begins, in an isotropic ultra-high pressure environment, the outer body of the bag wraps around the three-dimensional shape such as corners, adheres closely, penetrates into the gap, and binds to the sample. Even after pressurization is completed, the bonded form is maintained, causing process problems such as samples coming off when the outer body is removed.

In other words, if there is a gap or a difference in shape between the die plate and the sample, the bag adheres closely to and penetrates into the sample during pressurization, which may cause separation of the bag and sample during de-pouching, or removal of the bag after completion of pressurization to be not easy and smooth. In addition, in the past, in the composition of the pressurization sample, die, and bag, problems of adhesion occurred, such as the bag wrapping around the corner and sticking closely or penetrating into the gap during pressurization.

In order to improve the above-mentioned problems, the present disclosure proposes an all-solid-state battery manufacturing equipment and method having a new die cavity structure for isostatic pressurization, and an all-solid-state battery according to the same, as described below.

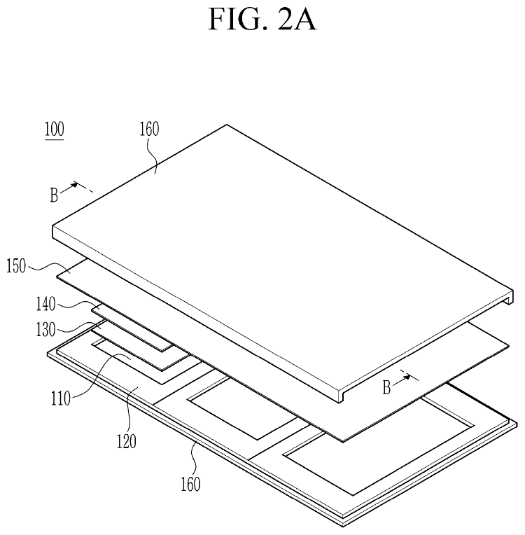

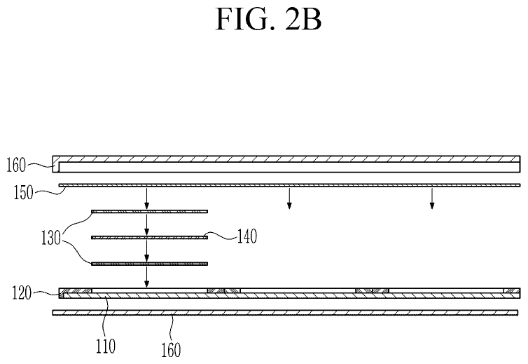

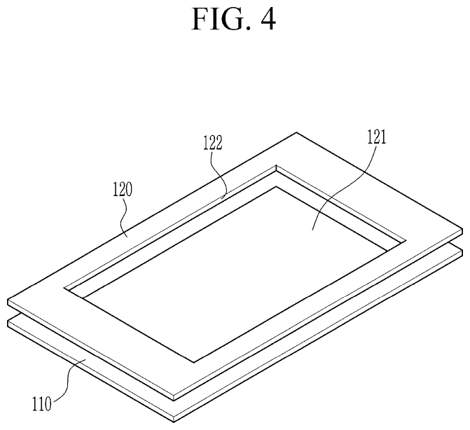

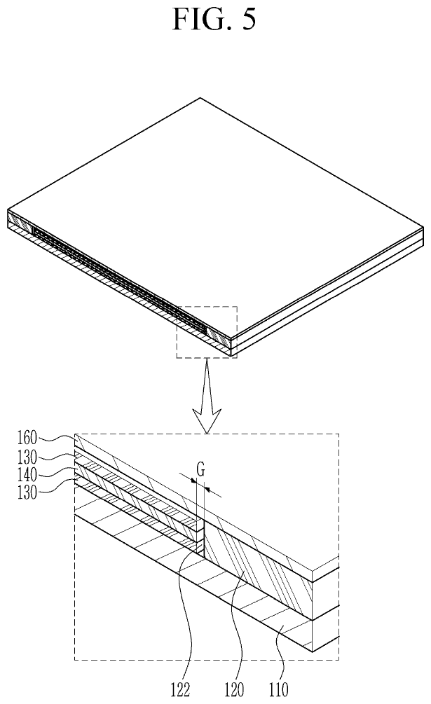

FIG. 2A is an exploded perspective view showing an exemplary manufacturing equipment of an all-solid-state battery according to the present disclosure, FIG. 2B is a cross-sectional view of a manufacturing equipment of the all-solid-state battery of FIG. 2A taken along B-B line, and FIG. 4 is an enlarged perspective view showing a structure of the die cavity of FIG. 2A, and FIG. 5 is an enlarged perspective view showing a side surface of the all-solid-state equipment of FIG. 2A. FIGS. 2A and 2B illustrate cross-sectional pressing based on the metal die 110.

As shown in FIG. 2A to FIG. 2B, an exemplary manufacturing equipment of an all-solid-state battery according to the present disclosure 100 may include the metal die 110, a rubber die 120, a lamination film 150 and a rubber punch 160. Here, the rubber punch 160 may be disposed on an upper portion of the lamination film 150, and may be integrally shaped like a cover.

In some examples, the rubber punch 160 may be formed as a pair in a vertically symmetrical structure, and each may be disposed in the upper portion of the lamination film 150. The rubber punch 160 in the vertically symmetrical structure may include an upper rubber punch and a lower rubber punch, and may be integrally shaped like a cover.

An exemplary manufacturing equipment of an all-solid-state battery according to the present disclosure 100 is an equipment configured to isostatically pressurize the all-solid-state battery 1 shown in FIG. 1 through a composite structure of the rubber die 120 having the metal die 110 and cavity.

The metal die 110 may have a flat plate shape, and may be provided as a metallic material. Additionally, the surface of the metal die 110 on which the battery material 130 is placed is in contact with the rubber cavity 121 and may have a micro-embossed protrusion of approximately 1 mm. The metal die 110 may be made of a rigid metal material for the purpose of preventing bending and distortion of the pressurization sample based on the area of the pressurization sample during pressurization in the vertical direction.

The rubber die 120 may have a flat plate shape, have the cavity 121, and may be disposed on the metal die 110 of the flat plate shape. Pressurized samples 130 and 140 may be placed inside the cavity 121. The cavity 121 may be provided in a shape corresponding to the shape of the pressurization samples 130 and 140 disposed therein. For example, if the pressurization samples 130 and 140 have a rectangular shape, the cavity 121 may also be provided in a rectangular shape to correspond thereto.

The rubber die 120 surrounds the outer shape of the pressurization samples 130 and 140 and has a level difference in thickness (height) of the pressurization samples 130 and 140, and has dimensions and shape to have a gap of an appropriate size for loading and unloading of the pressurization samples 130 and 140. The pressurization samples 130 and 140 may include at least one battery material 130 and an intermediate film 140.

The rubber die 120 may be provided to correspond to the outer shape and height of the pressurization samples 130 and 140, and may have a gap G at the boundary between the side wall 122 of the cavity 121 and the pressurization samples 130 and 140.

The rubber die 120 may be made of a rubber material and may be deformed during pressurization to fill the gap G with the pressurization samples 130 and 140. In some examples, the rubber die 120 may be deformed by pressurization to fill the gap G with the pressed samples 130 and 140, resulting in prevention of penetration of the lamination film 150 stacked on the pressurization samples 130 and 140. In some examples, the rubber die 120 may return to its original shape when the pressure is released after completion of pressurization, and may further apply tension to the lamination film 150 to separate it from the pressurization samples 130 and 140.

The battery material 130 may be a unit cell or a stack of unit cells including a negative electrode current collector layer, a negative electrode layer, a solid electrolyte layer, a positive electrode layer, and a positive electrode current collector layer. The intermediate film 140 may be a film disposed between unit cells in consideration of improving pressure uniformity between unit cells or other physical characteristics of the all-solid-state battery. In addition, the intermediate film 140 may be disposed between the battery material 130 and the surface of the rubber die 120 as a release film for smooth separation of the battery material 130 from the surface of the rubber die 120.

When isostatic pressing is applied to the rubber die 120 in the vertical direction by the rubber punch 160, the rubber die 120 may be deformed to provided elasticity such that the side wall 122 of the cavity 121 may contact the pressurization samples 130 and 140. When the isostatic pressing on the rubber die 120 due to the rubber punch 160 is released, the rubber die 120 is restored to an original state to provide elasticity for the side wall 122 of the cavity 121 to become spaced apart from the pressurization samples 130 and 140. As an example, the rubber die 120 may include urethane, silicon, or elastomer.

The lamination film 150 may have a flat plate shape, and after the pressurization samples 130 and 140 is disposed in the cavity 121 of the rubber die 120, may cover the rubber die 120 including the cavity 121.

Meanwhile, since the shape of the rubber die 120 and the arrangement of the pressurization samples 130 and 140 are top/bottom symmetrical, the fixation of the pressurization samples 130 and 140 during the transfer and loading of the rubber die 120 and the all-solid-state battery is necessary. Accordingly, the lamination film 150 is laminated on the rubber die 120 in order to provide appropriate adhesion between the rubber die 120 and the lamination film 150.

The lamination film 150 fixes the pressurization samples 130 and 140, such as an all-solid electrolyte, a positive electrode, a negative electrode, an intermediate film, in the cavity 121 of the rubber die 120, and may protect surfaces of the pressurization samples 130 and 140 between the rubber punch 160 transferring the pressurizing force and the pressurization samples 130 and 140.

The lamination film 150 may penetrate into the gap G between the side wall 122 of the cavity 121 and the pressurization samples 130 and 140 during pressurization, but the penetration may be interfered due to the deformation of the cavity 121 of the rubber die 120, and even if it is penetrated, it may be separated from the pressurization samples 130 and 140 due to the deformation of the rubber when the pressurization is released.

The rubber punch 160 may have a flat plate shape, and may cover the lamination film 150. The rubber punch 160 may be made of a heat-resistant material such as urethane or silicon. The rubber punch 160 is structured to surround the rubber die 120 and the pressurization samples 130 and 140, and may serve to provide the function of space separation between pressurization medium and the rubber die 120 and the pressurization samples 130 and 140, and during pressurization, may serve to adapt to the shape of the pressurization object and transfer the isostatic pressurizing force.

Since the all-solid-state an equipment 100 according to the present disclosure configured as described above replaces a corner edge portion of the rubber die 120 surrounding the pressurization samples 130 and 140, i.e., a cavity stepped portion, with a rubber mold, the rubber die 120 of the cavity structure is deformed during pressurization and the gap G with the pressurization samples 130 and 140 is filled such that the penetration of the lamination film 150 may be interfered or minimized.

After pressurization, the shape of the rubber die 120 of the cavity structure is restored to its original shape, the lamination film 150 having penetrated into the gap G is pulled to further separate it from the pressurization samples 130 and 140. Accordingly, as the adhesion between the pressurization samples 130 and 140 and the lamination film 150 is resolved, delamination automation for removing the lamination film 150 may be facilitated, and as a result, due to the automation cost reduction and increase of process reliability, the manufacturing cost of an all-solid-state battery pressurization process may be decreases.

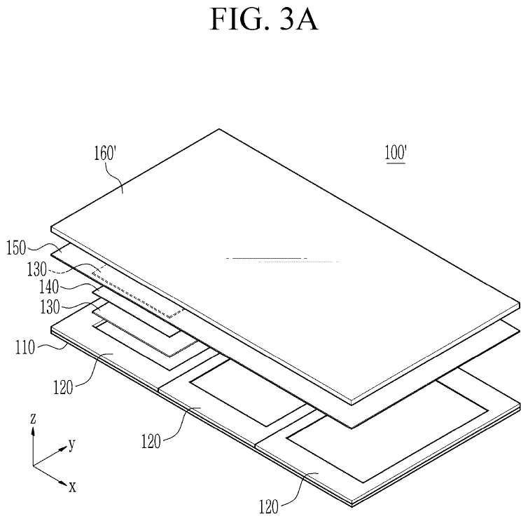

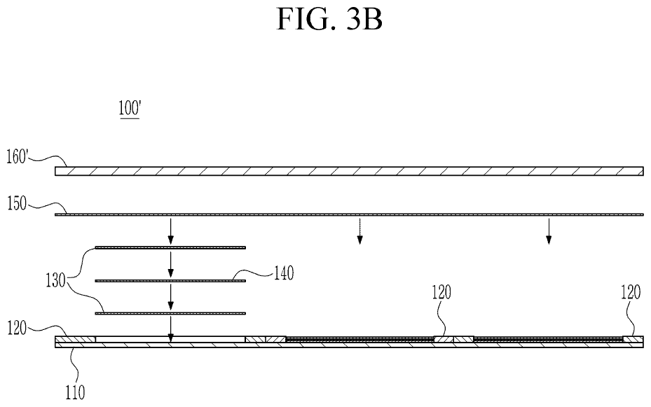

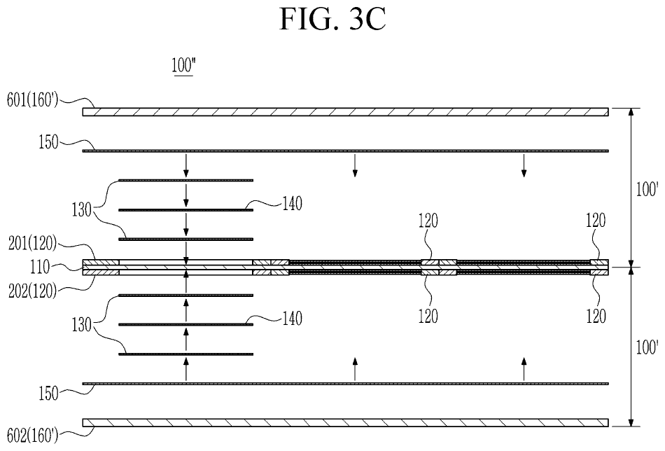

FIG. 3A is an exploded perspective view showing another exemplary manufacturing equipment of an all-solid-state battery according to the present disclosure, and FIG. 3B is a cross-sectional view showing pressing of a single surface of an all-solid-state battery by the manufacturing equipment of the all-solid-state battery of FIG. 3A. FIGS. 3A and 3B illustrate pressurization on both surfaces in the vertically symmetrical structure based on the metal die 110.

Referring to FIG. 3A and FIG. 3B, an exemplary manufacturing equipment 100′ of an all-solid-state battery according to the present disclosure may include the metal die 110, the rubber die 120, the lamination film 150 and the rubber punch 160′. Here, in the rubber punch 160′ in the vertically symmetrical structure, the upper rubber punch and the lower rubber punch may have a flat plate shape.

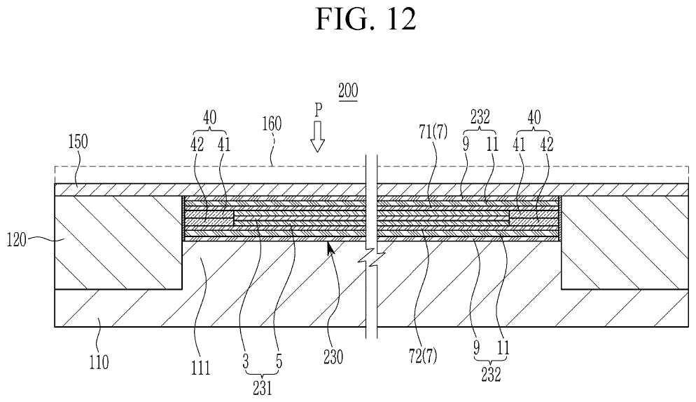

The metal die 110 may have a micro-embossed protrusion of approximately 1 mm on the surface on which the battery material 130 is placed in contact with the rubber cavity. That is, the metal die 110 may include a flat surface portion 111 (see FIG. 12) coupled to the cavity 121 of the rubber die 120 and planarly formed to protrude to support an all-solid-state battery 130 inserted into the cavity 121.

The rubber die 120 may be provided in a plural quantity along at least one direction among a first direction (x-axis direction) and a second direction (y-axis direction) crossing each other, to form an area of the cavity 121. In the manufacturing equipment 100′ of the present disclosure, a plurality of rubber dies 120 are provided along x-axis direction, and each may be provided with the cavity 121.

The metal die 110 may be formed as a plurality of flat plates corresponding to a plurality of rubber dies 120, respectively, but as shown in the drawings, may be formed as one flat plate entirely supporting the plurality of rubber dies 120.

The metal die 110 made of one flat plate is advantageous for supporting the rubber dies 120 at the same height. The rubber die 120 and the rubber punch 160′ may be disposed on an upper surface of the metal die 110 and configured to pressurize the all-solid-state battery 130 on a first surface of the metal die 110.

FIG. 3C is a cross-sectional view of a manufacturing equipment of an all-solid-state battery that presses both surfaces of an all-solid-state battery. Referring to FIG. 3C, a manufacturing equipment 100″ is provided with a rubber die 120 and a rubber punch 160′ in a vertically symmetrical structure centered on the metal die 110. As the cavity 121 of the rubber die 120 is disposed on the upper surface and a lower surface of the metal die 110, productivity may be improved.

In the manufacturing equipment 100″, the rubber die 120 may include a first die 201 and a second die 202, and the rubber punch 160′ may include a first punch 601 and a second punch 602. The first die 201 may be an upper rubber die, the second die 202 may be a lower rubber die, the first punch 601 may be the upper rubber punch, and the second punch 602 may be the lower rubber punch.

The first die 201 and the first punch 601 may be disposed on the upper surface of the metal die 110, and may pressurize the all-solid-state battery 130 on the upper surface of the metal die 110. The second die 202 and the second punch 602 may be disposed on the lower surface of the metal die 110, and may pressurize the all-solid-state battery 130 on the lower surface of the metal die 110.

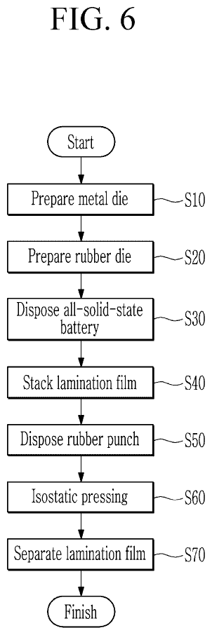

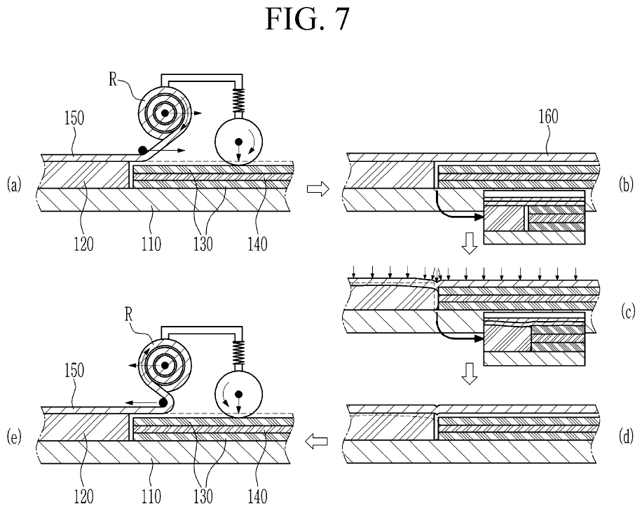

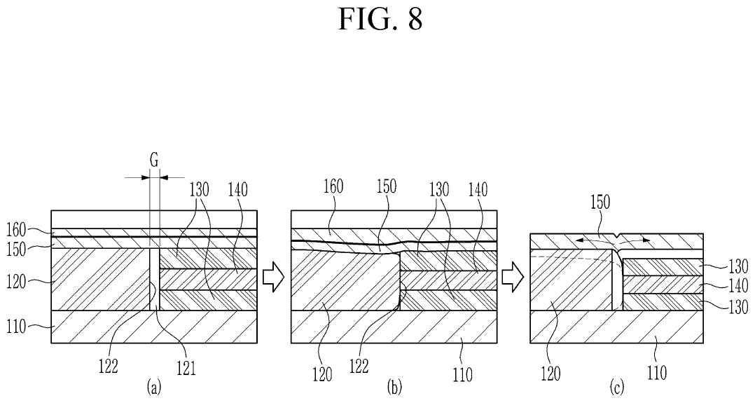

FIG. 6 is a flowchart showing an exemplary manufacturing method of an exemplary all-solid-state battery using an exemplary manufacturing equipment of an all-solid-state battery according to the present disclosure, FIG. 7 is a flowchart schematically showing a lamination process and a delamination process among the manufacturing method of the all-solid-state battery of FIG. 6, and FIG. 8 is a cross-sectional view showing states of the die cavity before and after the pressing by the manufacturing method of the all-solid-state battery of FIG. 6.

Referring to FIG. 6, a manufacturing method of an all-solid-state battery according to another embodiment of the present disclosure may include a first step S10 of preparing the metal die 110 of a flat plate shape, a second step S20 of disposing the rubber die 120 having cavity on the metal die 110, a third step S30 of disposing the all-solid-state battery (or the pressurization samples 130 and 140) in a cavity of the rubber die 120, a fourth step S40 of covering the all-solid-state battery and the rubber die 120 by the lamination film 150, a fifth step S50 of covering the lamination film 150 by the rubber punch 160, and a sixth step S60 of applying isostatically pressing to the rubber punch 160.

In addition, a manufacturing method of an all-solid-state battery according to another embodiment of the present disclosure may include a seventh step S70 of separating the lamination film 150 after the isostatic pressing.

When the isostatic pressing is applied to rubber die 120 by the rubber punch 160 at the sixth step S60, the rubber die 120 may be deformed such that the side wall 122 of the cavity 121 may contact the all-solid-state battery 130. When the isostatic pressing applied to the rubber die 120 is released by the rubber punch 160, the rubber die 120 is restored to its original state such that a side wall of the cavity may become spaced apart from the all-solid-state battery 130. At this time, the isostatic pressing may be performed hydraulically using water or oil.

This method may be equally applied to the pouching process for wet isostatic pressing of all-solid-state batteries as well as dry isostatic pressing.

Referring to FIG. 7, in the manufacturing method of the all-solid-state battery using an exemplary manufacturing equipment of an all-solid-state battery according to the present disclosure, the lamination of the fourth step S40, the isostatic pressing of the sixth step S60, and the delamination process of the seventh step S70 will be described in detail.

The lamination process of the fourth step S40 may include a process (a) of stacking the lamination film 150 on the rubber die 120 and the pressurization samples 130 and 140 by using a film roll equipment R, and a process (b) of completing stacking of the lamination film 150 and waiting, the isostatic pressing process of the sixth step S60 may include a process (c) of applying the isostatic pressing on the lamination film 150 completed with the stacking in the vertical direction, and a process (d) of releasing the pressure when the isostatic pressing is completed, and the delamination process of the seventh step S70 may include a process (e) of removing the lamination film 150 by using the film roll equipment R. More specifically, the process (a) is the lamination process of the fourth step S40, and the process (e) corresponds to the delamination process of the seventh step S70.

As shown in FIG. 8(a), before the isostatic pressing of the fourth step S40, the gap G may be provided between the side wall 122 of the cavity 121 of the rubber die 120 and the pressurization samples 130 and 140. The gap G is a region where the lamination film 150 may penetrate during pressurization. As shown in FIG. 8(b), during the isostatic pressing of the sixth step S60, the side wall 122 of the cavity 121 of the rubber die 120 of a rubber material may be deformed in the gap G direction, and as a significant portion of the gap G is filled, the penetration of the lamination film 150 is primarily interfered.

As shown in FIG. 8(c), when the pressure is released after the isostatic pressing of the sixth step S60 is completed, as the deformation of the rubber die 120 returns to the original shape, corresponding to the returning, the adhesion portion of the lamination film 150 is also be further separated from the pressurization samples 130 and 140, and as the tension force generated at this time pulls the wrinkled portion to be flat, residue of penetration and adhesion of the lamination film 150 may be secondarily interfered.

As such, the present disclosure may minimize the gap between the cavity and the pressurization sample during isostatic pressing, and by applying tension to the penetrated lamination film portion after the pressing, adhesion between the lamination film and the pressurization sample and the process trouble during the delamination step may be prevented.

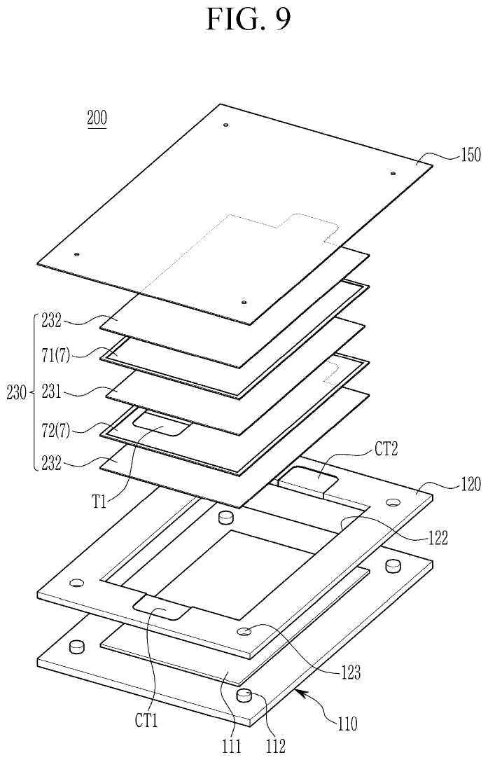

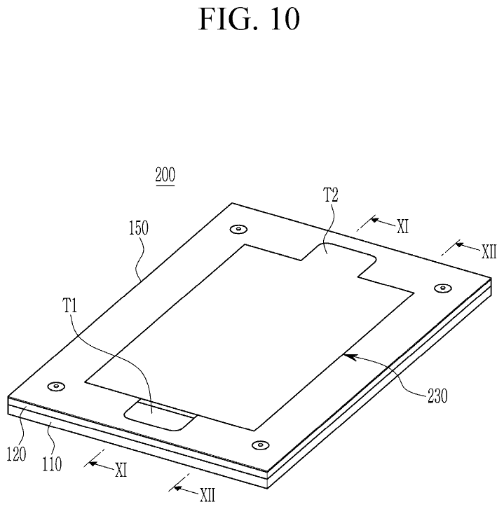

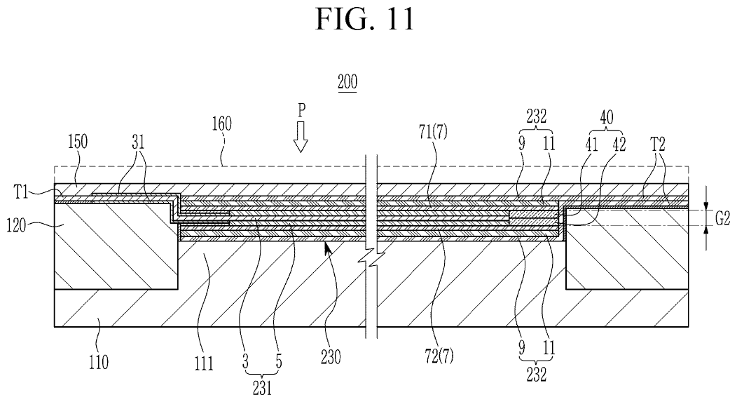

FIG. 9 is an exploded perspective view showing an exemplary manufacturing equipment of an all-solid-state battery according to the present disclosure and first all-solid-state battery, FIG. 10 is a perspective view showing an assembly of a first all-solid-state battery and the manufacturing equipment of the exemplary all-solid-state battery of FIG. 9, and FIG. 11 is a cross-sectional view of FIG. 10 taken along line XI-XI, and FIG. 12 is a cross-sectional view of FIG. 10 taken along line XII-XII.

An exemplary manufacturing equipment 200 of an all-solid-state battery according to the present disclosure shown in FIG. 9 to FIG. 12 has the same basic structure as the manufacturing equipment 100 of FIG. 2A to FIG. 2B, and detailed description on such may be omitted. The manufacturing equipment 200 of FIG. 9 to FIG. 12 shows an example of the single cavity 121 of the rubber die 120. A first all-solid-state battery 230 of the present disclosure corresponds to the pressurization sample 130 applied with the isostatic pressing P in the manufacturing equipment 200 of the all-solid-state battery.

Referring to FIG. 9 to FIG. 12, the all-solid-state battery 230 of the present disclosure may include a positive electrode 231 provided with the positive electrode layer 5 on both surfaces of the positive electrode current collector layer 3, a pair of solid electrolyte layers 7 (71, 72) disposed on both surfaces of the positive electrode 231, and a negative electrode 232 disposed in each of the solid electrolyte layers 7 (71, 72) and provided with the negative electrode layer 11 on both surfaces of the negative electrode current collector layer 9. In the positive electrode current collector layer 3, a positive electrode tab T1 provided with an insulation coating layer 31 may protrude, and in the positive electrode current collector layer 3, a negative electrode tab T2 may protrude.

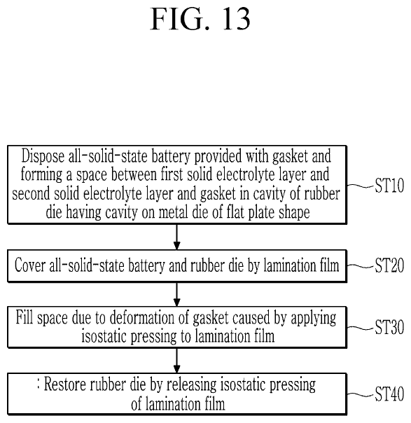

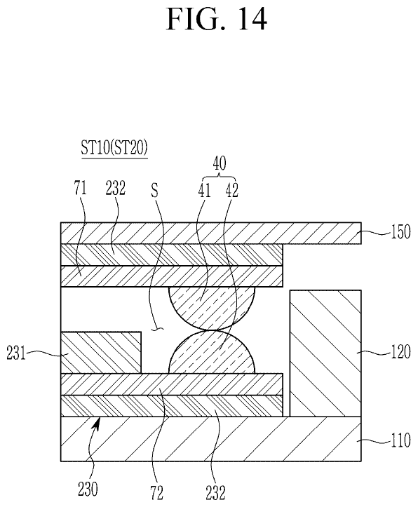

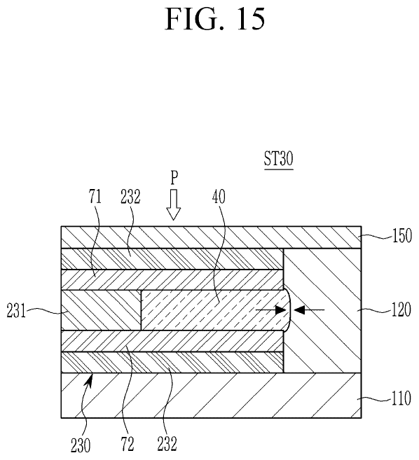

FIG. 13 is a flowchart showing a manufacturing method of an all-solid-state battery using an exemplary manufacturing equipment of an all-solid-state battery according to the present disclosure, FIG. 14 is a partial cross-sectional view of the first all-solid-state battery and the manufacturing equipment of the all-solid-state battery in the first step among the manufacturing method of FIG. 13, and FIG. 15 is a partial cross-sectional view of the first all-solid-state battery and the manufacturing equipment of the all-solid-state battery in the third step among the manufacturing method of FIG. 13. For convenience, the configuration of the all-solid-state battery 230 of the present disclosure will be described together with a manufacturing method of an all-solid-state battery.

Referring to FIG. 13 to FIG. 15, a manufacturing method of an all-solid-state battery of the present disclosure may include a first step ST10, a second step ST20, a third step ST30, and a fourth step ST40. In the first step ST10, the all-solid-state battery 230 including the negative electrode 232, a first solid electrolyte layer 7 (71), the positive electrode 231, a second solid electrolyte layer 7 (72), and the negative electrode 232, provided with a gasket 40 (41, 42) between the first and second solid electrolyte layers 71 and 72, and forming a space S defined by the gasket 40 between the first and second solid electrolyte layers 71 and 72 is disposed in the cavity 121 of the rubber die 120 having a cavity on the metal die 110 of the flat plate shape.

The metal die 110 may be provided with the flat surface portion 111 inserted in the cavity 121 of the rubber die 120 and planarly formed to protrude to support the all-solid-state battery 230, and an engagement protrusion 112 engaged with an engagement hole 122 of the rubber die 120.

The rubber die 120 may be connected to the cavity 121, and may further include tab cavities CT1 and CT2 surrounding the positive electrode tab T1 and the negative electrode tab T2. Accordingly, when the all-solid-state battery 230 is surrounded by the cavity 121, the positive electrode tab T1 and the negative electrode tab T2 is bent and surrounded by the tab cavities CT1 and CT2, and accordingly, do not interfere the isostatic pressing P of the all-solid-state battery 230. That is, when applying the isostatic pressing P, the tab cavities CT1 and CT2 may enable the planar pressure acting on the surface of the all-solid-state battery 230 to be uniform.

Referring to FIG. 13 and FIG. 14, in the first step ST10, being provided with the gasket 40 may mean being provided with a first member 41 on a first solid electrolyte layer 71, and facing the first member 41, being provided with a second member 42 on a second solid electrolyte layer 72.

Referring to FIG. 9 to FIG. 12, FIG. 13 and FIG. 14, the second step ST20 covers the all-solid-state battery 130 and the rubber die 120 by the lamination film 150. The lamination film 150 fixes the all-solid-state battery 230 to the rubber die 120, thereby protecting the all-solid-state battery 230 and preventing separation during transport and process. To this end, the lamination film 150 has appropriate adhesive strength with respect to the rubber die 120, so that a lamination may be formed on the rubber die 120. When the gap between the cavity 121 of the rubber die 120 and the all-solid-state battery 230 is excessive, the lamination film 150 may penetrate into the gap when applying the isostatic pressing P, and then, when the pressurization is released, may be drawn out from the gap due to the elastic restoration of the rubber die 120.

Referring to FIG. 9 to FIG. 12, FIG. 13 and FIG. 15, the third step ST30 applies the isostatic pressing P to the lamination film 150 by the rubber punch 160, to fill the space S due to deformation of the gasket 40 (41, 42). In the third step ST30, in the deformation of the gasket 40 (41, 42), the first member 41 and the second member 42 are deformed to form one gasket 40. When the first member 41 and the second member 42 have different colors, they may be deformed to form a boundary in the gasket 40, which forms an integrated structure.

In the third step ST30, a uniform wall may be formed on an outer boundary of the all-solid-state battery 130 by the elastic force of the rubber die 120. That is, when applying the isostatic pressing P, the side wall 122 of the rubber die 120 is pushed toward an outer end portion of the positive electrode 231 and the gasket 40 is pushed inward. Accordingly, an inner end portion of the gasket 40 may be in tight contact with the outer end portion of the positive electrode 231.

That is, the gasket 40 has flexibility and fluidity, and fills the space S during applying of the isostatic pressing P, thereby uniformly completing the outer boundary of the all-solid-state battery 230. The gasket 40 may remove the non-uniformness of the planar pressure planarly acting on the all-solid-state battery 230 due to insufficient lateral supporting force of the positive electrode 231 when applying the isostatic pressing P, and may prevent bending and crack of the negative electrode 232 and the solid electrolyte layer 7. As an example, the gasket 40 may be formed of an all-solid electrolyte or polymer.

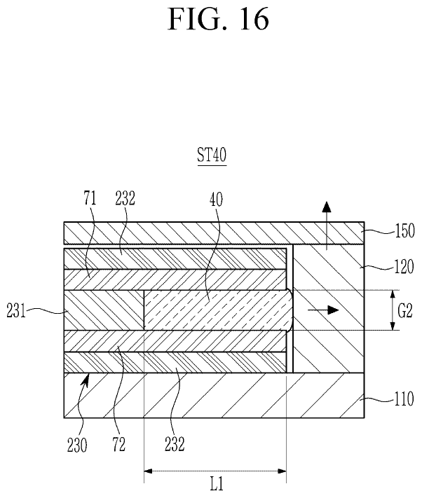

Referring to FIG. 9 to FIG. 12, FIG. 13 and FIG. 16, in the fourth step ST40, the isostatic pressing P of the lamination film 150 is released to restore the rubber die 120. The restoring force of the rubber die 120 may provide the force of separating the lamination film 150 from the first all-solid-state battery 230.

The first all-solid-state battery 230 manufactured by this manufacturing method may be formed as shown in FIG. 11, FIG. 12 and FIG. 16. That is, an outer end portion of the solid electrolyte layer 7 (71, 72) and an outer end portion of the negative electrode 232 may be disposed on the same line in a thickness direction (height direction in FIG. 11 and FIG. 12). The outer end portion of the positive electrode 231 may have a first distance difference L1 shorter than the outer end portion of the solid electrolyte layer 7 (71, 72).

The gap G2 of outer end portions of the pair of solid electrolyte layers 7 (71, 72) and a side surface of the outer end portion of the positive electrode 231 may form the space S (see FIG. 14) between each other in which the gasket 40 (41, 42) is interposed. When applying the isostatic pressing P, the gasket 40 (41, 42) fills the gap G2 between a pair of solid electrolyte layers 71 and 72 in the outer end portion of the positive electrode 231, and accordingly, the non-uniformness of the planar pressure planarly acting on the all-solid-state battery 230 may be removed, and bending and crack of the negative electrode 232 and the solid electrolyte layer 7 may be prevented.

An inner side of the gasket 40 (41, 42) may be in line with the thickness direction and planarly contact the outer end portion of the positive electrode 231. An outer end portion of the gasket 40 (41, 42) may be disposed on the same line with the outer end portion of the solid electrolyte layer 7 (71, 72) in the thickness direction.

Substantially, in the all-solid-state battery 230, the outer end portion of the gasket 40 (41, 42) may protrude beyond the outer end portion of the solid electrolyte layer 7 (71, 72). When applying the isostatic pressing P, the further protruding portion in the gasket 40 (41, 42) sufficiently fills the gap G2 between the pair of solid electrolyte layers 71 and 72 in the outer end portion of the positive electrode 231, and accordingly, the non-uniformness of the planar pressure planarly acting on the all-solid-state battery 230 may be sufficiently removed.

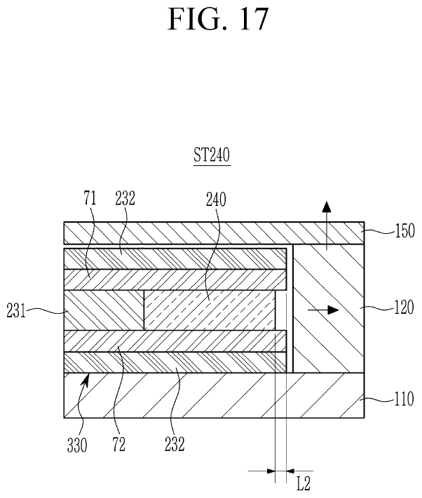

FIG. 17 is a partial cross-sectional view of the second all-solid-state battery and the manufacturing equipment of the all-solid-state battery in the fourth step among the manufacturing method of FIG. 13. Referring to FIG. 13 and FIG. 17, a second all-solid-state battery 330 is in the state that the rubber die 120 is restored by releasing the isostatic pressing in the fourth step ST240.

In the second all-solid-state battery 330, an outer end portion of a gasket 240 may have a second distance difference L2 shorter than the outer end portion of the solid electrolyte layer 7 (71, 72). When applying the isostatic pressing P, although the short portion of the gasket 40 (41, 42) may not be sufficient to fill the gap G2 between the pair of solid electrolyte layers 71 and 72 in the outer end portion of the positive electrode 231, with respect to the planar pressure planarly acting on the all-solid-state battery 230, crack of the negative electrode 232 and the solid electrolyte layer 7 may be prevented, and the outer end portion of the positive electrode 231 may be sufficiently protected.

Despite the second distance difference L2, in the third step ST30, a uniform wall may be formed on an outer boundary of the second all-solid-state battery 330 by the elastic force of the rubber die 120. That is, when applying the isostatic pressing, the side wall 122 of the rubber die 120 is pushed toward the outer end portion of the positive electrode 231, and pushes the gasket 240 inward. Accordingly, even in the second all-solid-state battery 330 from which the isostatic pressing is released in the fourth step ST240, an inner end portion of the gasket 240 may be in tight contact with the outer end portion of the positive electrode 231.

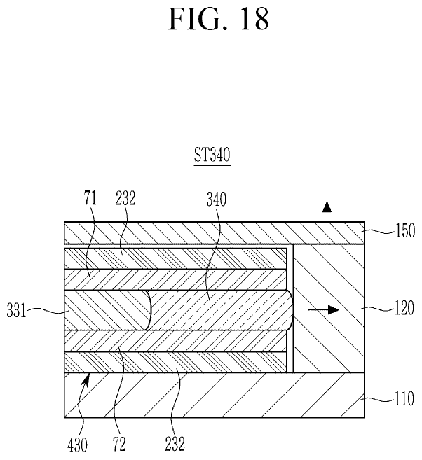

FIG. 18 is a partial cross-sectional view of the third all-solid-state battery and the manufacturing equipment of the all-solid-state battery in the fourth step among the manufacturing method of FIG. 13. Referring to FIG. 13 and FIG. 18, a third all-solid-state battery 430 is in the state that the rubber die 120 is restored by releasing the isostatic pressing in the fourth step ST340.

In the third all-solid-state battery 430, an inner side of a gasket 340 may form a protrusions-and-depressions structure in the thickness direction, and may contact a positive electrode 331 end portion through the protrusions-and-depressions structure. In addition, the inner side of the gasket 340 may form a concave structure in the thickness direction, and may contact a convex structure of the positive electrode 331 end portion.

Despite the contact of the protrusions-and-depressions structure or the contact of the concave structure and the convex structure, in the third step ST30, a uniform wall may be formed on an outer boundary of the third all-solid-state battery 430 by the elastic force of the rubber die 120. That is, when applying the isostatic pressing, the side wall 122 of the rubber die 120 is pushed toward the outer end portion of the positive electrode 331, and pushes the gasket 340 inward. Accordingly, even in the third all-solid-state battery 430 from which the isostatic pressing is release in in the fourth step ST340, the inner end portion of the gasket 340 may be in tight contact with the outer end portion of the positive electrode 331.

When applying the isostatic pressing P, the contact in protrusions-and-depressions structure or contact of concave and convex structures of the end portion of the positive electrode 331 and the gasket 340 sufficiently fills the gap G2 between the pair of solid electrolyte layers 71 and 72 in the outer end portion of the positive electrode 331, and accordingly, the non-uniformness of the planar pressure planarly acting on the all-solid-state battery 230 may be sufficiently removed.

What has been described above is only one embodiment for carrying the present disclosure. Therefore, the present disclosure is not limited to the above embodiments, and as claimed in the following claims, without departing from the gist of the present disclosure, it will be said that the technical features of the present disclosure are possible to the extent that various modifications can be made by a person with ordinary knowledge in the field to which the disclosure pertains.

(Description of symbols)

| | |
|---|---|
| 1: all-solid-state battery | |
| 3: positive electrode current collector layer | |
| 5: positive electrode layer | 7: solid electrolyte layer |
| 9: negative electrode layer | |
| 11: negative electrode current collector layer | |
| 31: insulation coating layer | 40: gasket |
| 41, 42: first, second member | |
| 71, 72: first, second solid electrolyte layer | |
| 100, 100′, 100: manufacturing equipment | |
| of an all-solid-state battery | |
| 200: manufacturing equipment of an all- | |
| solid-state battery | |
| 110: metal die | |
| 111: flat surface portion | 112: engagement protrusion |
| 120: rubber die | 121: cavity |
| 122: side wall | 123: engagement protrusion |
| 130: battery material (all-solid-state battery) | 140: intermediate film |
| 150: lamination film | 160, 160′: rubber punch |
| 201: first die | 202: second die |
| 230: first all-solid-state battery | 231, 331: positive electrode |
| 232: negative electrode | 240: gasket |
| 330: second all-solid-state battery | 340: gasket |
| 430: third all-solid-state battery | 601: first punch |
| 602: second punch | CT1: tab cavity |
| CT2: tab cavity | G, G2: gap |
| L1, L2: first, second distance | S: space |
| T1: positive electrode tab | T2: negative electrode tab |

1. A manufacturing equipment of an all-solid-state battery, the manufacturing equipment comprising:
a metal die of a flat plate shape;
a rubber die disposed on the metal die and having a cavity;
a lamination film configured to cover the rubber die comprising the cavity after the all-solid-state battery is disposed in the cavity of the rubber die; and
a rubber punch configured to cover the lamination film.

2. The manufacturing equipment of claim 1, wherein when isostatic pressing is applied to the rubber die by the rubber punch, the rubber die is deformed to provide elasticity such that a side wall of the cavity may contact the all-solid-state battery.

3. The manufacturing equipment of claim 2, wherein, when the isostatic pressing on the rubber die due to the rubber punch is released, the rubber die is restored to an original state to provide elasticity for the side wall of the cavity to become spaced apart from the all-solid-state battery.

4. (canceled)

5. The manufacturing equipment of claim 1, wherein the lamination film is of a flat plate shape.

6. The manufacturing equipment of claim 1, wherein the rubber punch is of flat plate shape.

7. The manufacturing equipment of claim 1, wherein the rubber die further comprises a tab cavity connected to the cavity, and configured to surround a positive electrode tab and a negative electrode tab of the all-solid-state battery.

8. The manufacturing equipment of claim 1, wherein the rubber die is provided in a plural quantity along at least one direction among a first direction and a second direction crossing each other, to form an area of the cavity.

9. (canceled)

10. The manufacturing equipment of claim 1, wherein the rubber die and the rubber punch is disposed on an upper surface of the metal die and configured to pressurize the all-solid-state battery on a first surface of the metal die.

11. The manufacturing equipment of claim 1, wherein the rubber die and the rubber punch comprises:
a first die and a first punch disposed on an upper surface of the metal die and configured to pressurize the all-solid-state battery on a first surface of the metal die; and
a second die and a second punch disposed on a lower surface of the metal die and configured to pressurize the all-solid-state battery on other both surfaces of the metal die.

12. The manufacturing equipment of claim 1, wherein the metal die comprises a flat surface portion coupled to the cavity of the rubber die and planarly formed to protrude to support the all-solid-state battery inserted into the cavity.

13. A manufacturing method of an all-solid-state battery, comprising:
a first step of preparing a metal die of a flat plate shape;
a second step of disposing a rubber die having a cavity on the metal die;
a third step of disposing an all-solid-state battery in the cavity of the rubber die;
a fourth step of covering the all-solid-state battery and the rubber die by a lamination film;
a fifth step of covering the lamination film by a rubber punch; and
a sixth step of applying an isostatic pressing to the rubber punch.

14. The manufacturing method of claim 13, wherein, in the sixth step, when the isostatic pressing is applied by the rubber punch, the rubber die is deformed such that a side wall of the cavity may contact the all-solid-state battery.

15. The manufacturing method of claim 13, wherein, in the sixth step, when the isostatic pressing is released by the rubber punch, the rubber die is restored to an original state such that a side wall of the cavity may become spaced apart from the all-solid-state battery.

16-18. (canceled)

19. An all-solid-state battery, comprising:
a positive electrode in which a positive electrode layer is provided on both surfaces of a positive electrode current collector layer;
a pair of solid electrolyte layers disposed on the both surfaces of the positive electrode; and
a negative electrode disposed in each of the solid electrolyte layers and provided with a negative electrode layer on both surfaces of a negative electrode current collector layer,
wherein an outer end portion of the solid electrolyte layer and an outer end portion of the negative electrode disposed on the same line in a thickness direction,
wherein an outer end portion of the positive electrode have a first distance difference shorter than the outer end portion of the solid electrolyte layer, and
wherein a gap of outer end portions of the pair of solid electrolyte layers and a side surface of the outer end portion of the positive electrode form a space between each other in which a gasket is interposed.

20. The all-solid-state battery of claim 19, wherein an inner side of the gasket is in line with the thickness direction and planarly contact the outer end portion of the positive electrode.

21. (canceled)

22. The all-solid-state battery of claim 19, wherein an outer end portion of the gasket protrudes beyond the outer end portion of the solid electrolyte layer.

23. The all-solid-state battery of claim 19, wherein an outer end portion of the gasket has a second distance difference shorter than the outer end portion of the solid electrolyte layer.

24. The all-solid-state battery of claim 19, wherein an inner side of the gasket forms a protrusions-and-depressions structure in the thickness direction, and contact the positive electrode end portion through the protrusions-and-depressions structure.

25. (canceled)

26. The manufacturing method of claim 13, wherein, in the third step, the all-solid-state battery comprises a negative electrode, a first solid electrolyte layer, a positive electrode, a second solid electrolyte layer, the negative electrode, and a gasket between the first solid electrolyte layer and the second solid electrolyte layer, and a space is defined by the gasket, the first solid electrolyte layer, and the second solid electrolyte layer.

27. The manufacturing method of claim 26, wherein, in the first step, the gasket comprises a first member on the first solid electrolyte layer, and a second member on the second solid electrolyte layer to face the first member, and
wherein, in the sixth step, the first member and the second member are deformed to fill the space and form one gasket.

28-30. (canceled)
